(19) United States
(12) Patent Application Publication
(10) Pub. No.: US 2005/0259058 A1
(43) Pub. Date: Nov. 24, 2005

(54) Liquid crystal display driver device and liquid crystal display system

(75) Inventors: satoshi Yamaguchi, Tokyo (JP); Masuhiro Endo, Kunitachi (JP); Takehiko Kubo, Ome (JP)

Correspondence Address: MILES & STOCKBRIDGE PC, 1751 PINNACLE DRIVE, SUITE 500, MCLEAN, VA, 22102-3833, US

(73) Assignee: Renesas Technology Corp.

(21) Appl. No.: 11/128,372

(22) Filed: May 13, 2005

(30) Foreign Application Priority Data
May 20, 2004 (JP) 2004-150016

(51) Int. Cl. G09G 3/36

(52) U.S. Cl. 345/87

(57) ABSTRACT

The present invention is directed to reduce the size of a liquid crystal driver (semiconductor integrated circuit for driving liquid crystal) having therein a D/A converting circuit, converting digital image data to analog gradation voltage, and outputting a voltage to be applied to a signal line (source line) of a color liquid crystal panel. Output amplifiers of the final stage for outputting an image signal converted to gradation voltage are divided into a plurality of groups. D/A converting circuits for converting image data to gradation voltage are provided as circuits common to the groups. While switching the group, the D/A converting circuit is operated in a time sharing manner. The output amplifiers in the final stage related to image signals of the same color are selected and grouped. A selector function is provided between the D/A converting circuit and the output amplifier, and an image signal converted to gradation voltage by the D/A converting circuit is supplied to a desired hold circuit.

### CROSS-REFERENCE TO RELATED APPLICATION

The present application claims priority from Japanese patent application No 2004-150016 filed on May 20, 2004, the content of which is hereby incorporated by reference into this application.

### BACKGROUND OF THE INVENTION

The present invention relates to a display driver device for driving a color display panel, a liquid crystal display driver device for driving a color liquid crystal panel and, further, a technique effective when applied to a liquid crystal display driver device formed on a semiconductor integrated circuit. The invention relates to, for example, a technique effective for use in a liquid crystal display driver device for driving a color liquid crystal display panel of a color television system.

A liquid crystal display system as one of display systems includes a liquid crystal display panel (hereinbelow, also called a liquid crystal panel) as a display panel, a liquid crystal display controller (liquid crystal controller) as a display controller, and a liquid crystal display driver system (liquid crystal display driver) as a display driver device for driving the liquid crystal display panel under control of the controller. A source driver for driving a source line as a signal line to which a pixel signal of the liquid crystal panel is applied is generally provided with, as shown in FIG. 16, digital-to-analog (DA) converting circuits DAC1, DAC2, . . . , and DACn for converting a digital image data signal to an analog voltage in correspondence with image signal output terminals Y1, Y2, . . . , and Yn.

In the driver of FIG. 16, as the D/A converting circuits DAC1, DAC2, . . . , and DACn, D/A converting circuits for outputting positive voltage and those for outputting negative voltage are alternately disposed. Data of a pixel of a source line is alternately input to a D/A converting circuit DACi for outputting positive voltage and a D/A converting circuit DACi+1 for outputting negative voltage by a multiplexer MPX1 and converted to an analog voltage, and the analog voltage is applied to the source line via a multiplexer MPX2. The electrode of each pixel is AC driven and the liquid crystal can be prevented from deteriorating (refer to, for example, Japanese Unexamined Patent Publication No. 2001-27750).

### SUMMARY OF THE INVENTION

In recent years, image data in a liquid crystal display system is constructed by plural pixel data. Pixel data of one pixel is constructed by red data (R) of eight bits, green data (G) of eight bits, and blue data (B) of eight bits. In many cases, the gradation display of a liquid crystal panel has 256 gradation levels per color (R, G, or B). As the picture quality of a liquid crystal display system becomes higher, a liquid crystal display system capable of performing display with higher-level gradation is in demand. The inventors of the present invention examined a source driver capable of performing display with high-level gradation such as 1,024 gradation levels per color (R, G, or B) when pixel data of each of colors (R, G, and B) of one pixel is, for example, 10 bits.

In a method of providing the D/A converting circuits DAC1, DAC2, . . . , and DACn for the image signal output terminals Y1, Y2, . . . , and Yn, the number of wires necessary for supplying both positive and negative gradation voltages to the D/A converting circuits is 2,048. Consequently, the wiring area of the wires for supplying the gradation voltages is wide. Even if the D/A converting circuits are disposed under the wires for supplying the gradation voltages (also called power supply lines), wasted space occurs. The inventors herein have found that the size of a semiconductor chip on which a liquid crystal driver, that is, a source driver is formed increases and it causes large increase in the cost of the source driver. To solve the problem, it is sufficient to decrease the number of D/A converting circuits mounted on the source driver and make the D/A converting circuits operate in a time sharing manner. In the method, however, time since image data is input until analog voltage is output becomes longer.

Since a liquid crystal panel having a larger number of source lines is provided as the size of a display screen increases and precision becomes higher recently, liquid crystal panels with various numbers of source lines coexist. One of methods of enabling a common source driver to be commonly used for the liquid crystal panels is to provide image signal output terminals in accordance with a liquid crystal panel having the largest source lines. The inventors herein, however, have also found that the method is not effective because the chip size of such a source driver is extremely large.

It may be considered to regulate the number of image signal output terminals of a source driver and construct a liquid crystal display system by using a plurality of source drivers. This method is effective from the viewpoint of decreasing the chip size of the source driver. In this case, however, it is necessary to pay attention to timings of switching the source driver to which image data is to be sent. When the timings are inaccurate, image data may not be accurately sent to the source driver and transmission time for transmitting image data to the source driver may increase.

An object of the invention is to decrease the size of a display driver device (liquid crystal driver and a semiconductor integrated circuit for driving liquid crystal).

Another object of the invention is to provide plural display driver devices (liquid crystal drivers) which are combined to construct a display system (liquid crystal display system).

Further another object of the invention is to provide plural display driver devices (liquid crystal drivers) capable of dynamically performing gamma correction in accordance with the characteristics of each color of a color display panel (color liquid crystal panel).

Further another object of the invention is to provide plural display driver devices (liquid crystal drivers) capable of performing display with high-level gradation while suppressing increase in the chip size.

The above and other objects and novel features of the invention will become apparent from the description of the specification and the appended drawings.

The outline of representative ones of inventions disclosed in the application will be described as follows.

Output amplifiers in the final stage for outputting an image signal converted to gradation voltage are divided into a plurality of groups. Digital-to-analog (D/A) converting circuits for converting image data to analog gradation voltage are provided as circuits common to the groups. While switching the group, the D/A converting circuit is operated in a time sharing manner. The output amplifiers in the final stage related to image signals of the same color are selected and grouped. A selector function is provided between the D/A converting circuit and the output amplifier, and an image signal converted to analog gradation voltage by the D/A converting circuit is supplied to a desired hold circuit.

With the means, the number of D/A converting circuits for making the D/A converting circuit operate in a time sharing manner is smaller than that of image signal output terminals, so that miniaturization of the display driver device (liquid crystal driver) can be realized.

In an image display system used by combining a plurality of display driver devices (liquid crystal drivers) of the invention, while D/A converting an image signal in a display driver device (liquid crystal driver) another display driver device (liquid crystal driver) can transmit the D/A converted image signal to the output amplifier. Consequently, the image signal can be output as gradation voltage within predetermined time since image data is input. Image data can be prevented from being inaccurately received by a display driver device (liquid crystal driver) or data transmission required time can be prevented from becoming longer.

Since output amplifiers in the final stage related to image signals of the same color are selected and grouped, the display controller (liquid crystal controller) can transfer continuous image data of the same color of one line in the display panel (liquid crystal panel). It is sufficient to switch color data three times for data of R, G, and B per line. Therefore, at the time of switching color data, by dynamically changing the gradation voltage of each color, gamma correction can be made. Since delay accompanying the switching is extremely small, gamma correction can be made without largely changing the data transmission timings and the system configuration.

Further, according to another invention of the application, a plurality of D/A converting circuits for converting image data to analog gradation voltage are disposed so as to be adjacent to each other in an almost center of a semiconductor chip in a direction orthogonal to the longitudinal direction of the semiconductor chip, and a plurality of wires for supplying gradation voltage to the D/A converting circuits are disposed along a direction orthogonal to the longitudinal direction of the semiconductor chip.

With the means, the display driver device (liquid crystal driver) outputs image signals of multiple stages such as 1,024 gradation levels. Even in the case where the area of the wires for supplying the gradation voltage becomes wide, wasted space is not created when the D/A converting circuits are disposed below the wires (power supply lines) for supplying the gradation voltage. Thus, the size of the semiconductor chip can be reduced.

Effects obtained by the representative ones of the inventions disclosed in the application will be briefly described as follows.

According to the present invention, miniaturization of the display driver device (liquid crystal driver and semiconductor integrated circuit for driving liquid crystal) can be realized.

According to the present invention, a plurality of display driver devices (liquid crystal drivers) can be combined to construct a display system (liquid crystal display system).

Further, according to the invention, the display driver device (liquid crystal driver) capable of dynamically conducting gamma correction according to the characteristics of each of colors of a color display panel (color liquid crystal panel) can be realized.

A display driver device (liquid crystal driver, semiconductor integrated circuit for driving liquid crystal) capable of performing display with high-level gradation while suppressing increase in the chip size can be realized.

### BRIEF DESCRIPTION OF THE DRAWINGS

FIG. 1 is a block diagram showing a schematic configuration of a liquid crystal driver circuit to which the invention is applied.

FIG. 2 is a block diagram showing a detailed configuration of a decoder, a sample and hold unit, and an output amplifier in the liquid crystal driver circuit of FIG. 1.

FIG. 3 is a block diagram showing an example of the configuration of a liquid crystal display system using a plurality of liquid crystal driver circuits of the embodiment.

FIG. 4 is a timing chart showing transmission timings of red image signals supplied from decoders of a set of four liquid crystal driver circuits to sample and hold units in the liquid crystal display system of FIG. 3.

FIG. 5 is a timing chart showing transmission timings of green image signals supplied from the decoders of a set of four liquid crystal driver circuits to the sample and hold units in the liquid crystal display system of FIG. 3.

FIG. 6 is a timing chart showing transmission timings of blue image signals supplied from the decoders of a set of four liquid crystal driver circuits to the sample and hold units in the liquid crystal display system of FIG. 3.

FIG. 7 is a timing chart showing timings of control signals and clocks supplied from a liquid crystal display controller to a liquid crystal driver circuit in the liquid crystal display system of FIG. 3.

FIG. 8 is a block diagram showing an example of the configuration of a timing controller.

FIG. 9 is a timing chart showing timings of latch clocks automatically generated by the timing controller.

FIG. 10 is a timing chart showing timings of various signals in the liquid crystal display system of FIG. 3.

FIG. 11 is a block diagram showing an example of the configuration of a unit sample and hold circuit in the sample and hold unit.

FIG. 12 is a timing chart showing operation timings of the unit sample and hold circuit of the sample and hold unit.

FIG. 13 is a plan view showing an example of the layout on a semiconductor chip of circuit blocks constructing the liquid crystal drier circuit of the embodiment.

FIG. 14 is a plan view showing the layout of D/A converting circuits in the decoder of the embodiment of FIG. 13.

FIG. 15 is a plan view showing the layout of a liquid crystal driver circuit examined prior to the present invention.

FIG. 16 is a block diagram showing a schematic configuration of the liquid crystal driver circuit examined prior to the present invention.

### DESCRIPTION OF PREFERRED EMBODIMENTS OF THE INVENTION

Preferred embodiments of the invention will be described hereinbelow with reference to the drawings.

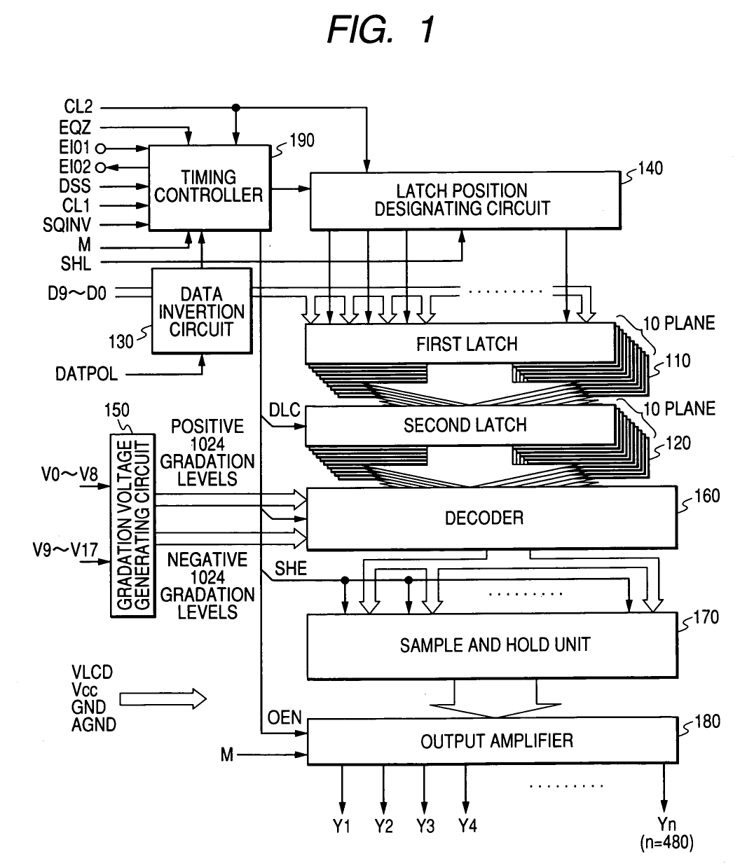

FIG. 1 shows a schematic configuration of a liquid crystal driver circuit to which the invention is applied. Although not limited, circuit blocks shown in FIG. 1 are constructed as semiconductor integrated circuits on a single semiconductor chip made of single crystal silicon or the like. The liquid crystal driver circuit of the embodiment is a circuit for outputting image signals Y1 to Yn to be applied to signal lines of a color liquid crystal panel of a dot matrix type in which a plurality of scan lines and a plurality of signal lines are arranged in a lattice shape and pixels are provided at intersecting points.

An embodiment of the invention will be described on assumption that, although not limited, pixel data of one pixel consists of 30 bits; 10 bits of color data of red (R), 10 bits of color data of green (G), and 10 bits of color data of blue (B).

A liquid crystal driver circuit of the embodiment includes: a first latch 110 for sequentially latching 10-bit input image data (10 bits of color data of one of three colors of red (R), green (G), and blue (B)); a second latch 120 for transferring the image data latched by the first latch 110 in a lump; a data inversion circuit 130 for inverting the data in accordance with a setting of a pixel to “black” when all of the input image data D9 to D0 is “1” or “0”; a latch position designating circuit 140 for designating the position in the first latch 110 in which the input image data D9 to D0 is latched; a gradation voltage generating circuit 150 for dividing gradation voltages V0 to V8 and voltages V9 to V17 supplied from the outside by a ladder resistor to generate positive voltages of 1,024 gradation levels and negative voltages of 1,024 gradation levels; a decoder (selector) 160 for selecting a voltage according to the image data held in the second latch 120 from the generated voltages, thereby converting the digital signal to an analog gradation voltage; a sample and hold unit 170 for holding the converted analog voltage; an output amplifier 180 for generating and outputting image signals Y1 to Yn according to the held voltage; and a timing controller 190 for generating an internal control signal which makes circuits in the semiconductor chip operate in predetermined order on the basis of clock signals and control signals supplied from the outside.

In the case of constructing a system for driving a liquid crystal panel having signal lines of the number larger than the number (n) of outputs of liquid crystal driver circuits of the embodiment which are connected in series, the timing controller 190 has a function of determining whether a liquid crystal driver circuit is the head liquid crystal driver circuit (an IC to which the first image data is supplied) or not in accordance with the state of a predetermined terminal EIO1 and outputting a signal indicating that the circuit outputs all of the image signals Y1 to Yn from a predetermined terminal EIO2. Concretely, the terminal EIO1 of the head liquid crystal driver circuit is fixed to the power source voltage Vcc, and the terminal EIO2 of the liquid crystal driver circuit at the ante-stage can is connected to the terminal EIO1 of the next stage, thereby enabling the plurality of liquid crystal driver circuits to be sequentially set in an image data latch state.

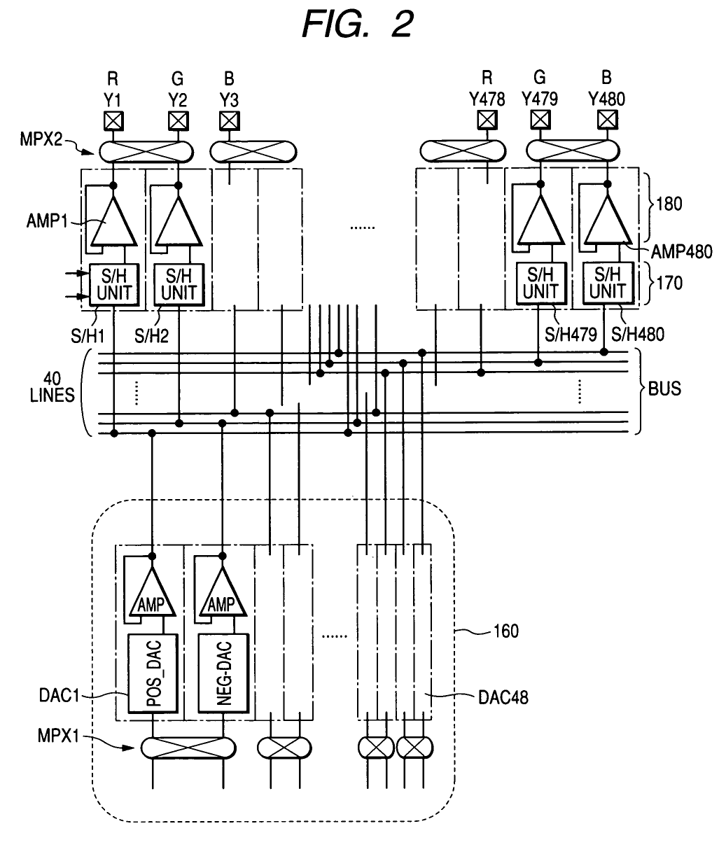

FIG. 2 shows a detailed configuration of the decoder 160, sample and hold unit 170, and output amplifier 180 in the liquid crystal driver circuit illustrated in FIG. 1.

In the embodiment, 480 pieces of unit sample and hold circuits S/H1 to S/H480 are provided in the sample and hold unit 170, and 480 pieces of output amplifiers AMP1 to AMP480 operating as voltage followers are provided in the output amplifier 180, the D/A converting circuits DAC1 to DAC40 and amplifiers of the number (40) which is 1/12 of 480 are provided. Although 40 pieces of circuits constructing the decoder 160 are called D/A converting circuits for convenience, and the decoder 160 can be constructed by selectors formed only by switch elements for selectively outputting a voltage according to an input code from a plurality of gradation voltages supplied from the gradation voltage generating circuit 150.

40 outputs of the decoder 160 are latched by 40 unit sample and hold circuits out of the 480 unit sample and hold circuits S/H1 to S/H480 via a bus BUS constructed by 40 signal lines. Concretely, 40 pieces of image data of the same color are input to the decoder 160, and the 40 image signals converted by the decoder 160 are latched by total 40 sample and hold circuits which are provided at intervals of two circuits in the sample and hold circuits S/H1 to S/H480 so that red image signals are output from the output terminals Y1, Y4, Y7, . . . , and Y478 out of the 480 output terminals Y1 to Y480 corresponding to signal lines connected to the red (R) pixels of the liquid crystal panel, green image signals are output from the output terminals Y2, Y5, Y8, . . . , and Y479 corresponding to signal lines connected to the green (G) pixels of the liquid crystal panel, and blue image signals are output from the output terminals Y3. Y6, Y9, . . . , and Y480 corresponding to signal lines connected to blue (B) pixels of the liquid crystal panel.

As the D/A converting circuits DAC1 to DAC40, D/A converting circuits for outputting positive voltage and those for outputting negative voltage are alternately disposed. Specifically, when the odd-numbered D/A converting circuits DAC1, DAC3, . . . , and DAC47 output positive voltage, even-numbered D/A converting circuits DAC2, DAC4, . . . , and DAC48 output negative voltage. The pixel data of a bit is alternately input to the D/A converting circuit DACi for outputting positive voltage and the D/A converting circuit DACi+1 for outputting negative voltage by the multiplexer MPX1 and converted to analog voltage. The analog voltage is transmitted to the sample and hold circuit and output via the multiplexer MPX2.

At this time, the multiplexers MPX1 and MPX2 operate similarly. Specifically, when the multiplexer MPX1 lets image data pass through, the multiplexer MPX2 also lets an image signal pass through. When the multiplexer MPX1 switches image data, the multiplexer MPX2 also switches a signal path so as to switch the image signal. By the operation, positive voltage and negative voltage are alternately applied to the electrode of each of pixels of the liquid crystal panel, and deterioration in the liquid crystal is prevented.

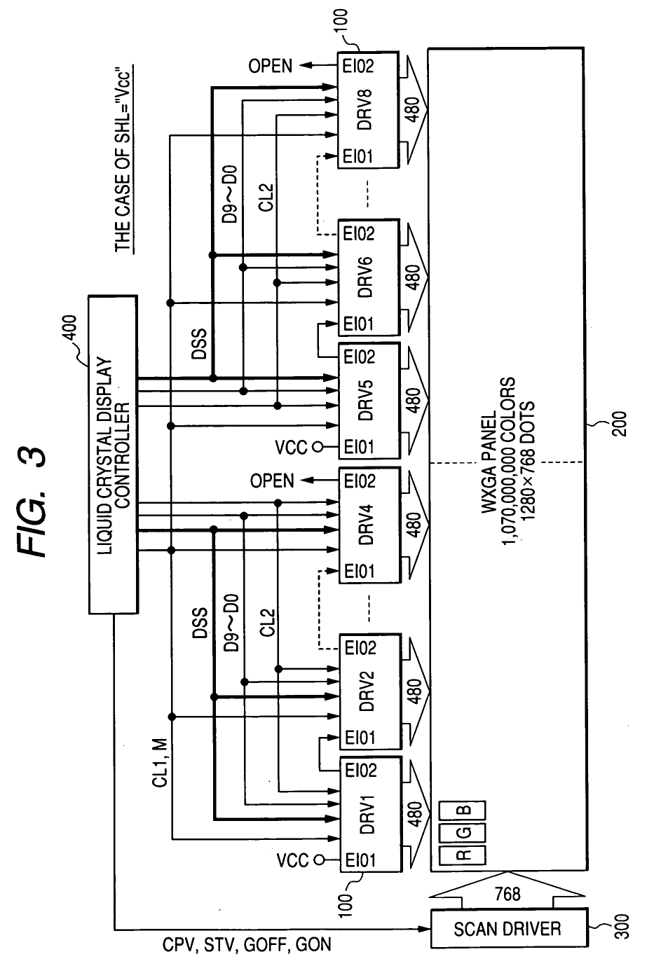

FIG. 3 is a block diagram showing the case where a system for driving a color liquid crystal panel 200 of 1,280×768 dots is constructed by using a plurality of liquid crystal driver circuits 100 of the embodiment. Eight liquid crystal driver circuits DRV1 to DRV8 are disposed in the line direction of the color liquid crystal panel 200. The liquid crystal driver circuits DRV1 to DRV8 are divided into two groups. The terminals EIO1 of the head liquid crystal driver circuits DRV1 and DRV5 of the groups are fixed to the power source voltage Vcc, and the terminals EIO2 of the liquid crystal driver circuits at the ante stages are electrically coupled to the terminals EIO1 of the remaining liquid crystal driver circuits DRV2 to DRV4 and DRV6 to DRV8. In such a manner, the liquid crystal driver circuits are connected in series by four.

300 denotes a scan line driving circuit (common driver) for sequentially setting common lines (which are called gate lines in a TFT panel) of the color liquid crystal panel 200 to a selection level. 400 denotes a liquid crystal display controller for generating a timing control signal to the scan line driving circuit 300, image data D9 to D0 to be supplied to the liquid crystal driver circuit, control signals DSS for controlling the liquid crystal driver circuits, and operation clocks CL1 and CL2.

The liquid crystal display controller 400 simultaneously outputs the image data D9 to D0 to the two scan line driving circuits. In the embodiment, the control signals DSS for notifying of start of transmission of image data and the clocks CL2 for notifying of latch timings are generated and supplied separately to the two sets of the liquid crystal driver circuits DRV1 to DRV4 and the liquid crystal driver circuits DRV5 to DRV8. Alternately, the signals may be supplied as common signals.

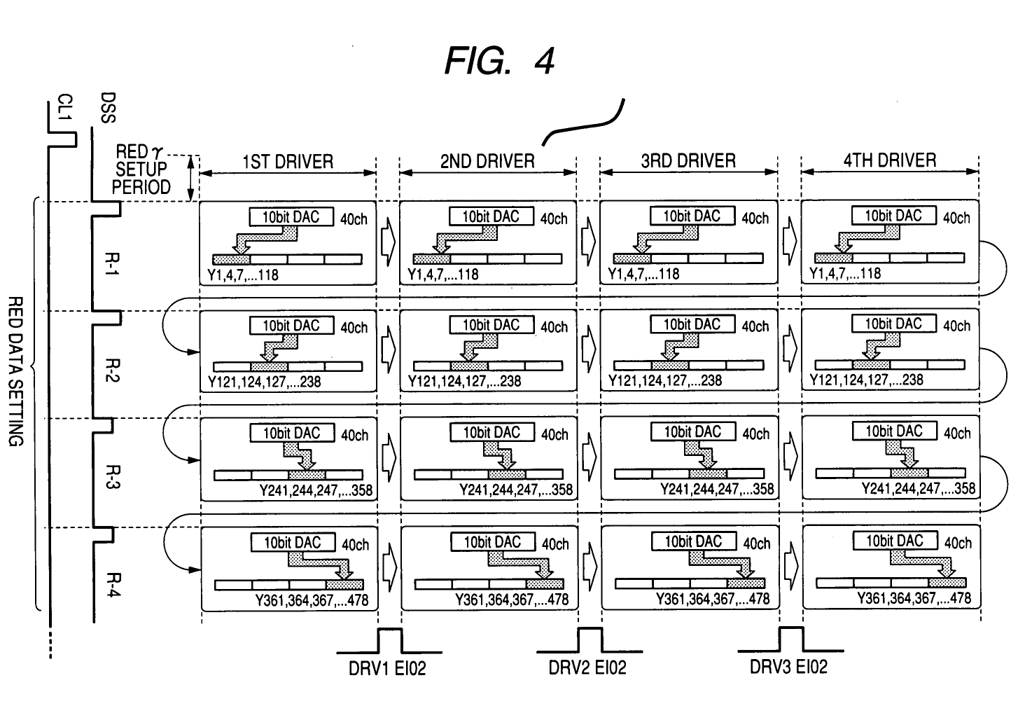

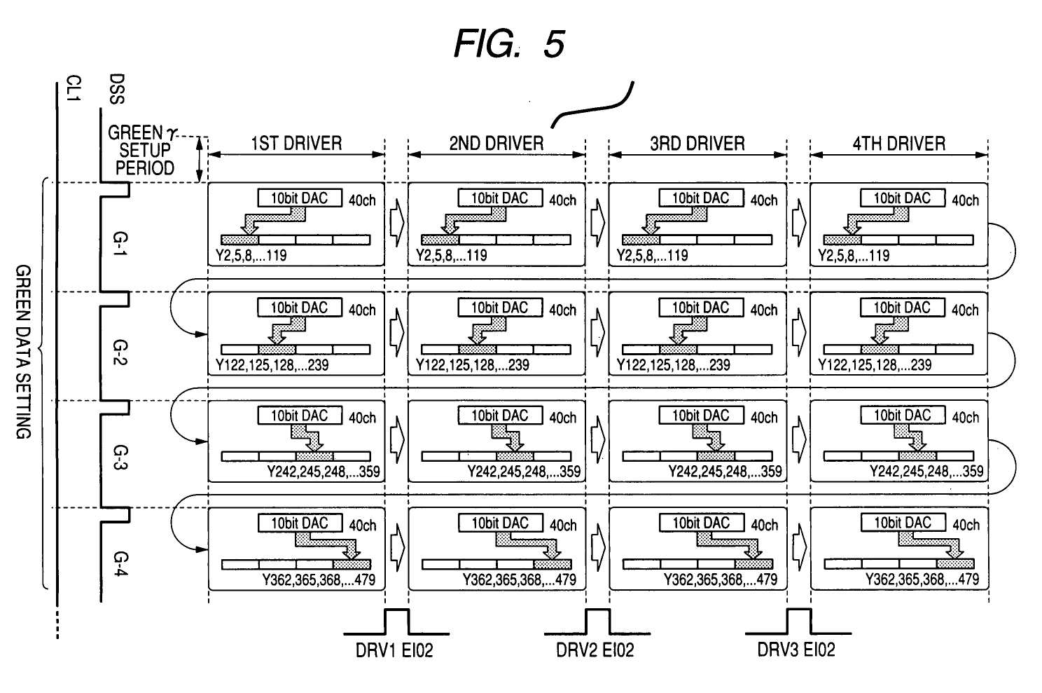

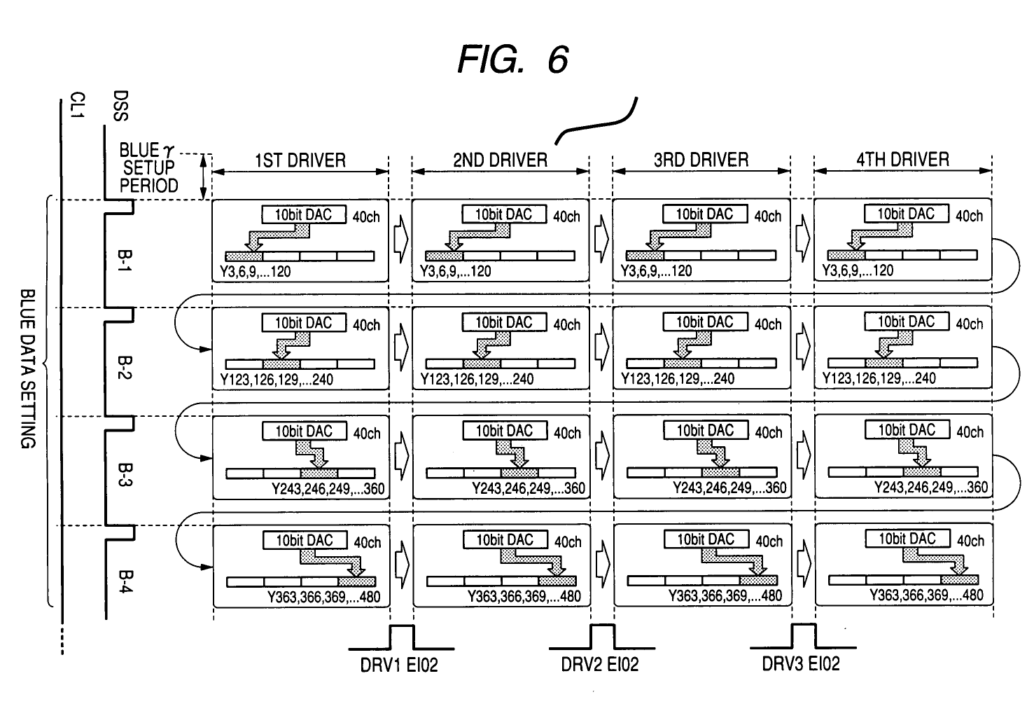

FIGS. 4 to 6 show transmission timings of image signals sent from the decoders 160 of the set of four liquid crystal driver circuits DRV1 to DRV4 or DRV5 to DRV8 to the sample and hold units 170 in the liquid crystal display system as shown in FIG. 3. The time elapses in order of FIGS. 4, 5, and 6. In each diagram, time elapses from the left to the right and then after reaching the right end, to the left end of the immediate lower line.

As understood from FIGS. 4 to 6, in the liquid crystal display system of the embodiment, first, image data of red of 40 pieces is transferred 16 times and D/A converted, and the obtained analog image data is held. After that, image data of green of 40 pieces is transferred 16 times and D/A converted, and the obtained analog image data is held. After that, image data of blue of 40 pieces is transferred 16 times and D/A converted, and the obtained analog image data is held.

By the operation, 1,920 pieces of image data corresponding to 640 dots which is the half of one line in the liquid crystal panel are transmitted and held. In the liquid crystal display system of the embodiment, short delay time is provided at the time of shift from transfer of image data of red to transfer of image data of green and, further, transfer of image data of blue. During the delay time, gamma correction of changing the voltage to be output is dynamically performed in accordance with gamma characteristic of the pixel of each color. In the liquid crystal display system of the embodiment, gamma correction can be dynamically performed relatively easily for the reason that image data is transmitted on the color unit basis of red, green, and blue.

In the display system of sequentially transmitting from data corresponding to the signal line at one end to image data corresponding to the other end in accordance with the configuration of the color liquid crystal panel, transfer of image data of red, transfer of image data of green, and transfer of image data of blue are repeated or performed at random. Consequently, gamma correction has to be made for each transfer of image data of each color. Delay time for the gamma correction has to be provided only by the amount corresponding to the number of pieces of image data, so that transfer of all of image data cannot be finished within one horizontal period.

In contrast, in the liquid crystal display system of the embodiment, image data is transferred on the color unit basis of red, green, and blue and it is sufficient to provide delay time for gamma correction three times only in one horizontal period. Thus, transfer of image data can be finished within one horizontal period.

The gamma correction in the liquid crystal driver circuit of the embodiment can be realized by switching between the voltages V0 to V8 and voltages V9 to V17 applied from the outside to the gradation voltage generating circuit 150 in FIG. 1 in accordance with the gamma characteristics of each of the colors of red, green, and blue.

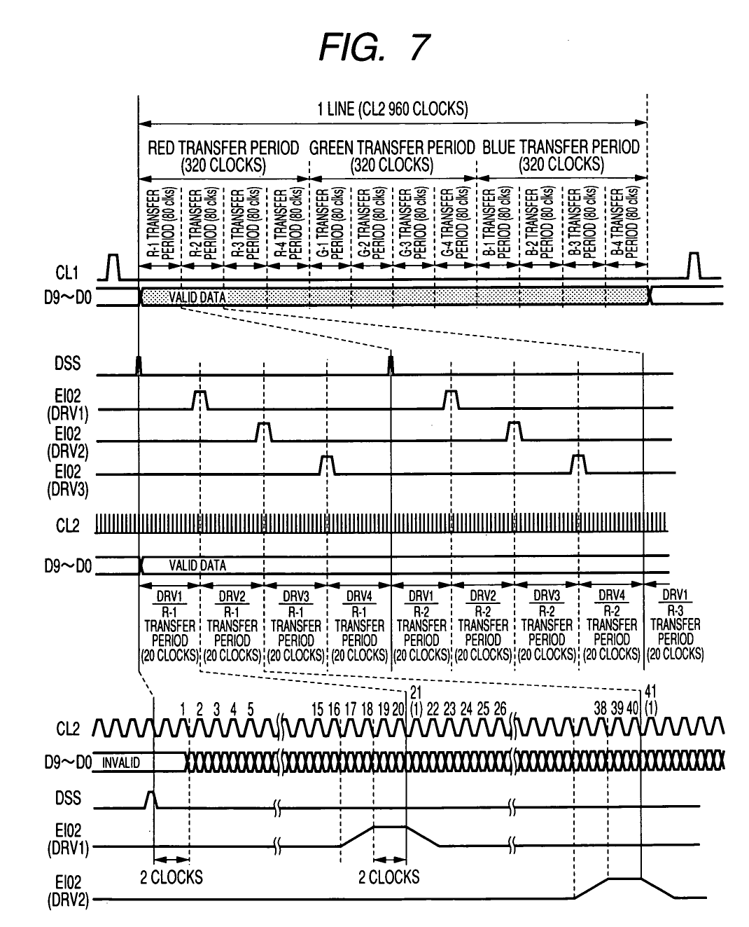

FIG. 7 shows timings of the data sampling start control signal DSS, clocks CL1 and CL2 for notifying of data latch timings or the like, and image data D9 to D0 supplied from the liquid crystal display controller 400 in the liquid crystal display system of FIG. 3 to the liquid crystal driver circuits DRV1 to DRV4 (DRV5 to DRV8) and data transmission end signal EIO2 output from each of the liquid crystal driver circuits DRV1 to DRV4.

The clock CL1 is a signal indicative of one horizontal period, and the control signal DSS is a signal for notifying of a data sampling start timing of each of the liquid crystal driver circuits DRV1 to DRV4. The control signal DSS becomes the high level four times in one horizontal period, that is, in one cycle of the clock CL1.

The clock CL2 is a clock for notifying of a latch timing of the image data D9 to D0. In the embodiment, the liquid crystal driver circuit is constructed so as to latch image data at each of the rising and trailing edges of the clock CL2. Consequently, the number of pulses of the clock CL2 in the period in which one liquid crystal driver circuit latches 40 pieces of image data, that is, in the period of one cycle of the data sampling start control signal DSS is 20.

The first liquid crystal driver circuit DRV1 starts latching image data after two pulses of the clock CL2 since the data sampling start control signal DSS changes. The signal EIO2 for notifying of the fact that the liquid crystal driver circuit has latched 40 pieces of image data becomes high level before the actual final data latching timing by two pulses of the clock CL2. In such a manner, the liquid crystal driver circuits DRV2 to DRV4 can continuously latch image data without delay after completion of the data latch of the driver at the ante stage.

The operation of the inside of the chip of the liquid crystal driver circuit DRV of the embodiment will now be described. Each of the circuit blocks in the liquid crystal driver circuit DRV is operated at a predetermined timing by a control signal from the timing controller 190, and the timing controller 190 generates an internal control signal which operates an internal circuit in accordance with a predetermined order on the basis of the clock signal and the control signal supplied from the outside.

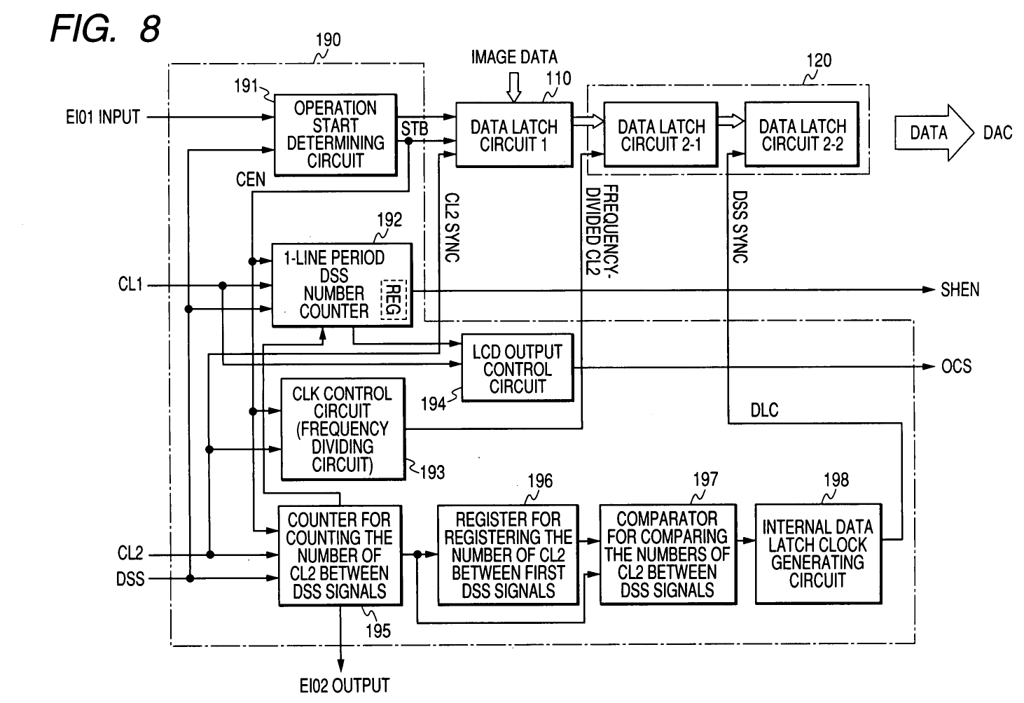

FIG. 8 shows an example of the configuration of the timing controller 190. The timing controller 190 of the embodiment includes: an operation start determining circuit 191 for generating control signals STB, CEN, and the like instructing the latch circuit 110 in the initial stage for latching image data on the basis of the input signal EIO1 and a counter for counting clocks, which will be described later, to be operative or to be in a standby state; a DSS counter 192 for counting the number of data sampling start control signals DSS in one horizontal period on the basis of the clock CL1 indicative of one horizontal period and generating an enable signal SHEN to the sample and hold unit 170; a clock control circuit 193 for frequency-dividing the clock CL2 for giving a data latch timing and generating a latch timing signal DLT for data latch timing, thereby generating a latch timing signal DLT of giving a timing of transferring image data latched by the first latch 110 to the second latch 120 in a lump; and an LCD output control circuit 194 for generating an output enable signal OEN which allows the output amplifier 180 to output an LCD image signal.

Although not shown in FIG. 1, in the liquid crystal driver circuit of the embodiment, the second latch 120 has a two-stage configuration of a latch circuit 121 of the first stage and a latch circuit 122 of the second stage. The timing controller 190 generates and supplies clocks for sequentially making the latch circuit 121 at the first stage and the latch circuit 122 at the second stage perform latching operation. The latch circuit 121 at the first stage operates as a master latch, the latch circuit 122 at the second stage operates as a slave latch, and image data latched by the second latch 120 can be prevented from being immediately supplied to the decoder 160 at the next stage.

Further, the timing controller 190 also includes: a CL2 counter 195 for counting the number of clocks CL2 between the data sampling start control signals DSS; a CL2 number register 196 for holding the number of the clocks CL2 between the first DSS signals in one line; a comparator 197 for comparing the number of clocks CL2 between the first DSS signals in one line with the number of clocks CL2 between second and subsequent DSS signals; and a latch clock generating circuit 198 for automatically generating the clock signal DLC for instructing the latch circuit 122 at the post stage in the second latch 120 to latch data in the case where DSS signals from the outside are not input for a period longer than the number of clocks CL2 between the first DSS signals on the basis of the comparison result of the comparator 197.

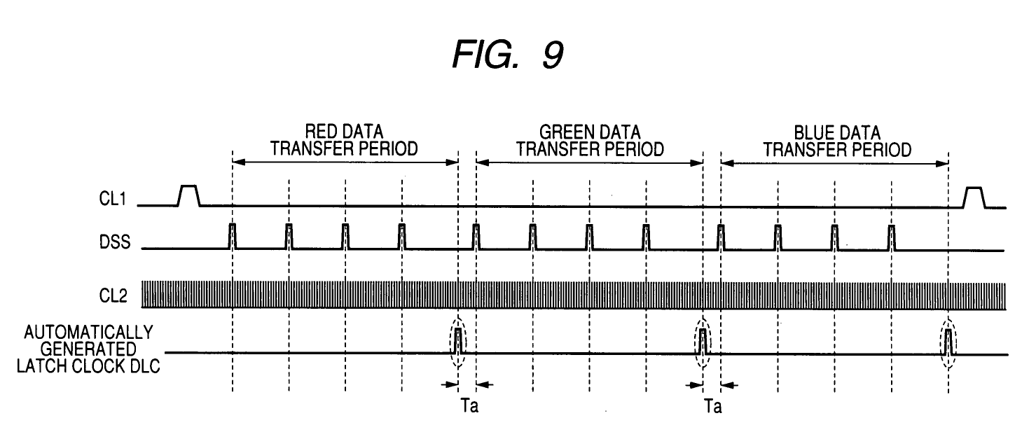

The latch clock generating circuit 198 is provided for a reason that, in the display system using the liquid crystal driver circuit of the embodiment and performing gamma correction, as shown in FIG. 9, a DSS signal is input with slight delay in order to provide an allowance period (Ta) for gamma correction in the transfer period of image data of each color, if the latch clock signal DLC for the latch circuit 122 is generated on the basis of only the DSS signal, a latch timing delays.

In the timing control circuit of the embodiment, at the time point when the CL2 counter 195 counts a predetermined number (16 clocks), the EIO2 signal to the liquid crystal driver circuit at the next stage can be set to the high level. Consequently, in the display system using a plurality of liquid crystal driver circuits, by preliminarily connecting the circuits so that the liquid crystal driver circuit at the next stage receives the signal by its EIO1 terminal, the liquid crystal display controller can transfer continuous image data without transmitting a unique start signal to each driver. Therefore, burden on the designer of the display system can be lessened.

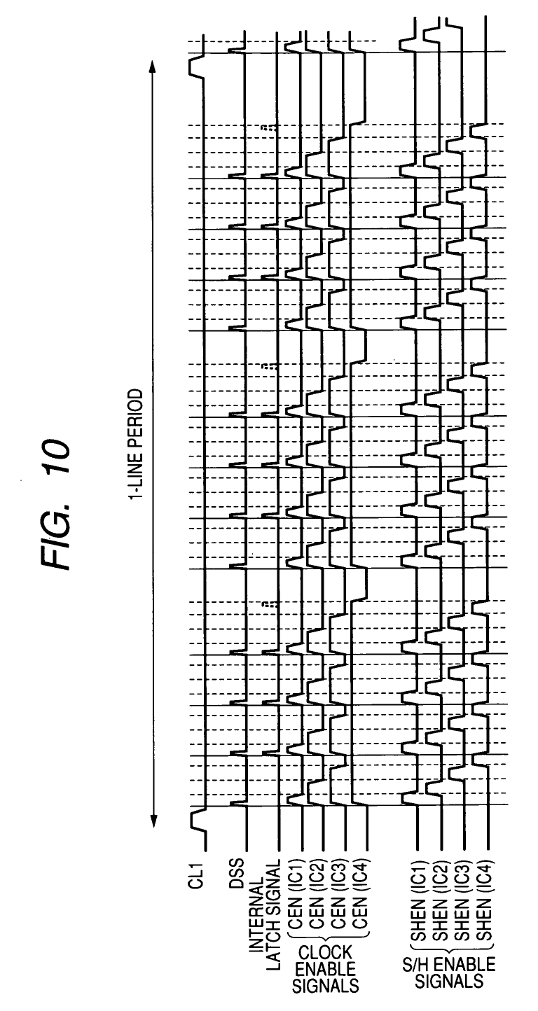

FIG. 10 shows timings of the data sampling start control signal DSS and clocks CL1 supplied to the liquid crystal driver circuits DRV1 to DRV4 (DRV5 to DRV8) in the liquid crystal display system as shown in FIG. 3 for displaying a color image to a liquid crystal panel by sequentially transferring image data by using eight liquid crystal driver circuits of the embodiment (which are grouped by four circuits), clock enable signal CEN generated in each of the liquid crystal driver circuits DRV1 to DRV4, sample hold enable signal SHEN, and EIO2 signal to be supplied to the liquid crystal driver circuit of the next stage.

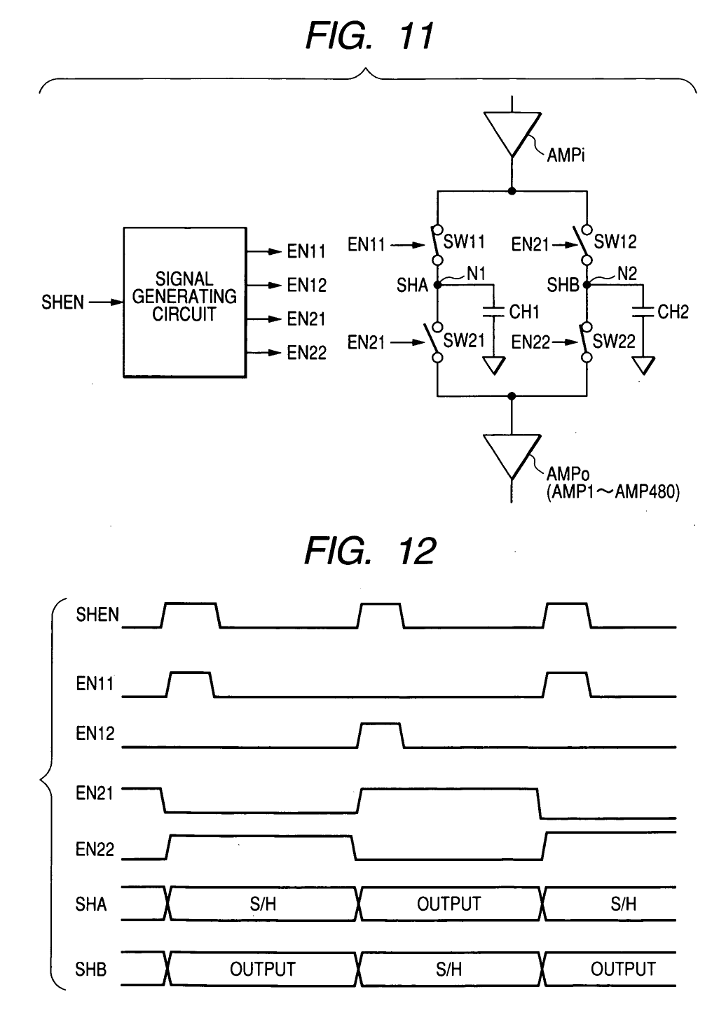

FIG. 11 shows an example of the configuration of the unit sample and hold circuit in the sample and hold unit 170. FIG. 12 shows the operation timings of the unit sample and hold unit 170.

The unit sample and hold circuit of the embodiment includes: a set of hold capacitors CH1 and CH2 for holding a voltage converted by the decoder 160; a pair of switches SW11 and SW12 connected between nodes N1 and N2 to which the output terminal of an amplifier AMPi on the input side and one of terminals of each of the hold capacitors CH1 and CH2 are connected; and a pair of switches SW21 and SW22 connected between the nodes N1 and N2 and the input terminal of an amplifier AMPo on the output side. The amplifiers AMP1 to AMP480 in FIG. 2 correspond to the amplifier AMPo in FIG. 11.

The switches SW11 and SW12 are turned on/off by control signals EN11 and EN12, respectively, and the switches SW21 and SW22 are turned on/off by control signals EN21 and EN22, respectively. Control is performed by the control signals EN11, EN12, EN21, and EN22 so that when the switch SW11 is turned on, the switch SW22 is turned on and, when the switch SW12 is turned on, the switch SW21 is turned on. Further, the control signals EN11, EN12, EN21, and EN22 are generated on the basis of the sample and hold enable signal SHEN so that the switches SW11 and SW21 are not in turned-on states simultaneously and the switches SW12 and SW22 are not in turned-on states simultaneously.

In the unit sample and hold circuit of the embodiment, when the switch SW11 is turned on, the switch SW21 is turned off, and the voltage (image signal) subjected to A/D conversion in the decoder 160 is sampled in the hold capacitor CH1. At this time, since the switch SW22 is turned on and the switch SW12 is turned off, the hold capacitor CH2 on the opposite side outputs the voltage sampled latest.

When an input voltage is sampled in the hold capacitor CH1, the switch SW11 is turned off, and the switch SW12 is turned on, thereby outputting the sampled voltage. At this time, in the hold capacitor CH2 on the opposite side, the switch SW12 is turned on, the switch SW22 is turned off, and the hold capacitor CH2 is charged with the voltage D/A converted by the decoder 160 and performs sampling.

By repeating the operations, the set of hold capacitors CH1 and CH2 alternately enter the sampling state and the hold state and the voltages (image signals) output from the decoder 160 are continuously sampled and sequentially output.

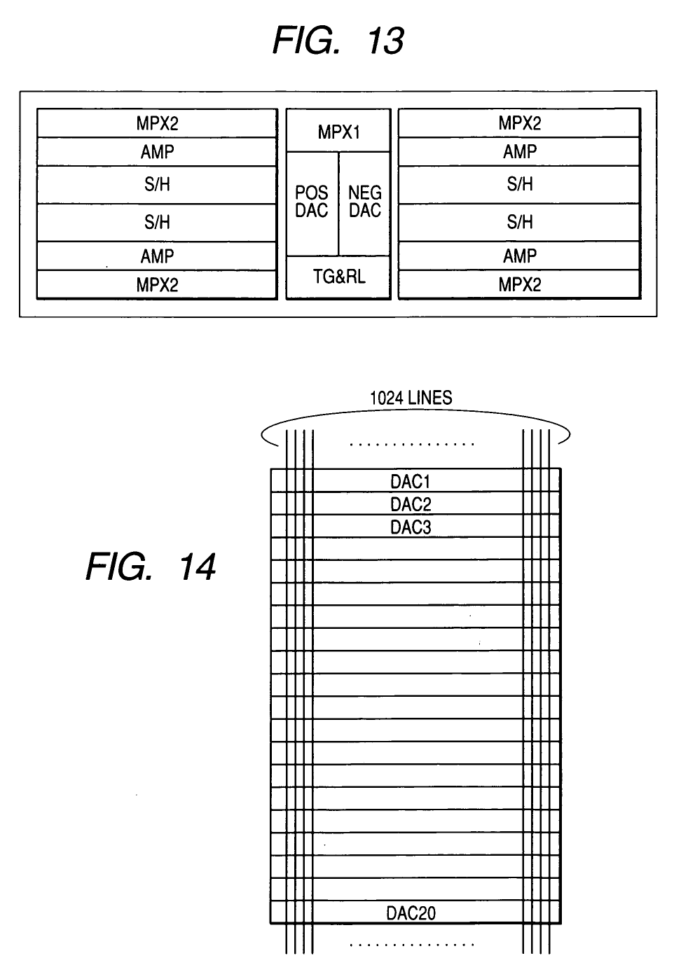

FIG. 13 shows an example of the layout on a semiconductor chip of the circuit blocks constructing the liquid crystal driver circuit of the embodiment. In FIG. 13, the same reference numerals are designated to circuits which are the same as those shown in FIG. 2.

As understood from FIG. 13, in the liquid crystal driver IC of the embodiment, a D/A converting circuit POS-DAC for outputting positive voltage and a D/A converting circuit NEG-DAC for outputting negative voltage are disposed in an almost center portion of the semiconductor chip so as to be adjacent to each other in the longitudinal direction of the semiconductor chip. A multiplexer MPX1 and a circuit TG & RL constructed by the timing controller (190) taking the form of a random logic and the gradation voltage generating circuit (150) constructed by a resistor ladder are disposed above and below the D/A converting circuits. On the right and left sides of those circuits, symmetrically, in order from above, the multiplexers MPX2, output amplifiers AMP, and sample and hold circuit S/H are disposed. Further, the sample and hold circuits S/H, output amplifiers AMP, and multiplexers MPX2 are disposed in this order symmetrically in the vertical direction.

Specifically, in each of the D/A converting circuit POS-DAC for outputting positive voltage and the D/A converting circuit NEG-DAC for outputting negative voltage, as shown in FIG. 14, 20 unit D/A converting circuits DAC1 to DAC20 are disposed in the direction orthogonal to the longitudinal direction of the semiconductor chip, and 1,024 power supply lines for supplying gradation voltages output from the timing control circuit and gradation voltage generating circuit TG & RL are provided above the unit D/A converting circuits DAC1 to DAC20.

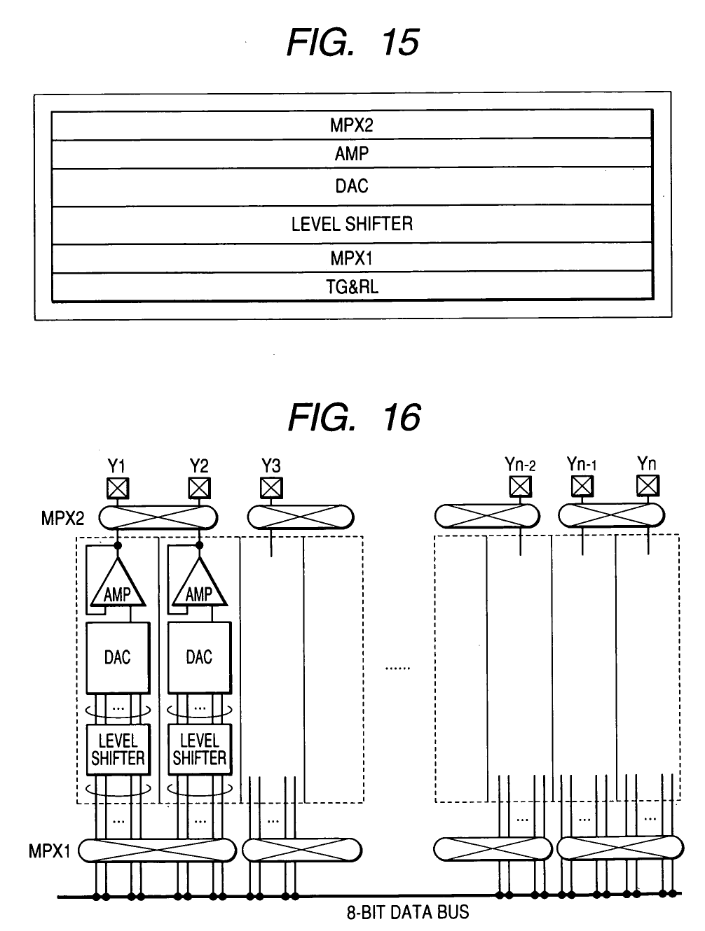

A liquid crystal driver IC of 256 gradation levels using image data of eight bits generally has a chip layout in which, as shown in FIG. 15, the multiplexer MPX2, output amplifier AMP, decoder DAC, level shifter, multiplexer MPX1, and timing control circuit and gradation voltage generating circuit TG&RL are disposed in order. The unit D/A converting circuits in the decoder of the number same as the number of output terminals are disposed in the longitudinal direction of the semiconductor chip. When the layout is applied to a liquid crystal driver IC of 1,024 levels using image data of 10 bits in a manner similar to the liquid crystal driver IC of the embodiment, power supply lines of the number which is four times as many as conventional power supply lines have to be disposed above the D/A converting circuits in the longitudinal direction. The power supply line becomes very lengthy and the width of the power supply line increases largely, so that wasted space is created below the power supply lines.

In contrast, in the layout as shown in FIGS. 13 and 14, it is sufficient to provide the power supply lines of gradation voltages in the direction orthogonal to the longitudinal direction of the semiconductor chip. Consequently, the power supply line becomes shorter. Even if the width of a plurality of power sources largely increases, without creating no wasted space below the power supply lines, the D/A converting circuits can be disposed. There is consequently an advantage such that increase in the chip size as the gradation becomes higher can be largely suppressed.

Although the invention achieved by the inventors herein has been concretely described on the basis of the embodiments, obviously, the invention is not limited to the foregoing embodiments but can be variously changed without departing from the gist. For example, in the foregoing embodiment, the case where image data consists of 10 bits and the gradation voltage has 1,024 levels has been described. The invention is not limited to the foregoing embodiment and can be also applied to the case where image data consists of 9 bits and the gradation voltage has 512 levels, and the case where image data consists of 11 bits and gradation voltage has 2,048 levels. In the embodiment, for 480 output amplifiers, 40 D/A converting circuits (that is, 1/12 of 480) are provided. Alternately, D/A converting circuits of the number which is ⅛ or 1/16 of the output amplifiers may be provided.

Further, in the foregoing embodiment, the terminal which outputs the signal EIO2 indicative of the end of latch of image data when the numerical value of the counter for counting clock signals input synchronously with image data reaches a predetermined value is provided, and the signal of the terminal is input as the data latch permit signal EIO1 to the driver IC of the next stage. It is also possible to omit the terminal for outputting the signal EIO2 and supply the data latch permit signal EIO1 from the liquid crystal display controller 400.

The invention achieved by the inventors herein has been described mainly with respect to the liquid crystal driver circuit for driving the liquid crystal panel in the field of utilization as the background of the invention. The invention however is not limited to the liquid crystal driver circuit but can be generally applied to drive circuits of a color display system for converting color image data given by a digital code to an analog voltage and outputting the analog voltage.

1. A display driver device comprising:
a data latch circuit for latching image data input from the outside;
a converting circuit for converting the image data latched by the data latch circuit to a corresponding voltage and outputting the corresponding voltage; and
output amplifiers of the number corresponding to the number of output terminals and outputting a drive voltage according to the output of said converting circuit,
wherein said converting circuit is provided as a circuit common to a plurality of groups of said output amplifiers and operates in a time sharing manner,
a plurality of pieces of image data converted at once by said converting circuit are image data of the same color,
a plurality of pieces of image data of the same color are input continuously and converted to a voltage by said converting circuit, the voltage is supplied to output amplifiers corresponding to said group, and
the device comprises a first terminal to which a start signal indicative of the head data of a plurality of pieces of image data of the same color is input prior to input of the head image data when the plurality of pieces of image data of the same color are continuously input, and
a second terminal to which a permit signal instructing latching of said image data which is continuously input.

2. The display driver device according to claim 1, further comprising:
an external terminal to which a clock signal synchronized with said image data is input;
a counter for counting clock signals input from the external terminal, which starts counting said clock signals after said start signal is input; and
a third terminal for outputting a signal indicative of the end of latching of the image data when the count value of the counter reaches a predetermined value.

3. The display driver device according to claim 1, wherein said image data is image data of red, image data of green, and image data of blue,
said output terminal and output amplifier related to a red image signal, those related to a green image signal, and those related to a blue image signal are repeatedly disposed in a predetermined order, and
said output amplifiers disposed at intervals of two output amplifiers are grouped.

4. A liquid crystal display driver device comprising:
a first latch circuit for sequentially latching image data input from the outside;
a second latch circuit for latching the image data in a lump, which was sequentially latched by the first latch circuit;
a converting circuit for outputting a voltage according to the image data sequentially latched by the second latch circuit as an image signal;
a hold circuit for holding the image signal output from the converting circuit; and
an output amplifier for outputting a drive voltage according to the image signal held by the hold circuit,
wherein said converting circuit is provided as a circuit common to a plurality of groups of said output amplifiers,
to said first latch circuit, a plurality of pieces of image data of the same color are continuously input, the image signal converted to the voltage by said converting circuit is supplied to the hold circuit corresponding to said group, and the device comprises a first terminal to which a start signal indicative of the head data is input prior to input of the head image data of a plurality of pieces of image data of the same color to the first latch circuit.

5. The liquid crystal display driver device according to claim 4, further comprising a second terminal to which a permit signal instructing latching of said image data which is continuously input is input.

6. The liquid crystal display driver device according to claim 5, further comprising:
an external terminal to which a clock signal synchronized with said image data is input;
a counter for counting clock signals input from the external terminal; and
a third terminal, when said first latch circuit latches a clock signal synchronously with said clock signal, said counter starts counting said clock signal after said start signal is input, and the count value of the counter reaches a predetermined value, for outputting a signal indicative of the end of latching of the image data.

7. The liquid crystal display driver device according to claim 4, further comprising:
a register for holding the number of clock signals input between said start signal input to said first terminal and the next start signal; and
a comparator for comparing the number of clock signals held in the register with the number of clock signals counted by said counter,
wherein when the count value of said counter becomes larger than the number held in said register by a predetermined number, a signal instructing latching of data is supplied to said first latch circuit.

8. The liquid crystal display driver device according to claim 4, wherein after a plurality of pieces of image data of a first color are continuously input, before a plurality of pieces of image data of a second color are input, gamma correction of adjusting a gradation voltage value supplied to said converting circuit is made in accordance with a gamma characteristic of a pixel corresponding to the second color.

9. The liquid crystal display driver device according to claim 8, further comprising a gradation voltage generating circuit for generating a plurality of gradation voltages by dividing a voltage applied from the outside, and supplying the gradation voltages to said converting circuit,
wherein said gamma correction is performed by changing the voltage applied from the outside to the gradation voltage generating circuit.

10-13. (canceled)
